(19) United States
(12) Patent Application Publication
(10) Pub. No.: US 2026/0073198 A1
(43) Pub. Date: Mar. 12, 2026

(54) METHOD AND SYSTEM FOR CROSS-DOMAIN PREDICTIVE MODELING USING BEDROCK BASED FOUNDATION MODELS AND BLOCKCHAIN-ANCHORED DATA

(71) Applicant: Naveen Kumar VAYYASI, Blue Bell, PA (US)

(72) Inventor: Naveen Kumar VAYYASI, Blue Bell, PA (US)

(21) Appl. No.: 19/391,823

(22) Filed: Nov. 17, 2025

(51) Int. Cl. G06N 3/0475; G06F 18/21; G06F 18/2413; G06F 18/25; G06N 3/048; H04L 9/00; H04L 9/06; H04L 9/32

(52) U.S. Cl. CPC G06N 3/0475; G06F 18/217; G06F 18/2414; G06F 18/253; G06N 3/048; H04L 9/0618; H04L 9/3236; H04L 9/3252; H04L 9/50; H04L 2209/463

(57) ABSTRACT

The present invention relates to a system and method for cross-domain predictive modeling using Bedrock-based foundation models and blockchain-anchored data. The invention integrates large-scale foundation model reasoning with distributed ledger-based data provenance to enable verifiable, secure, and explainable predictive analytics across heterogeneous domains such as finance, healthcare, logistics, and environmental systems. The system comprises a data ingestion unit for receiving and normalizing multi-domain datasets, a blockchain anchoring unit for generating cryptographic hashes and recording data provenance into a distributed ledger, a cross-domain harmonization processor for aligning heterogeneous feature representations into a unified latent space, a foundation model processor configured to execute Bedrock-based predictive inference with adaptive domain contextualization, a verification processor for validating predictions against blockchain-anchored ground truths, and a governance processor for maintaining immutable audit trails of model evolution.

### FIELD OF THE INVENTION

The present invention relates generally to artificial intelligence and data analytics, and more particularly to systems and methods for cross-domain predictive modeling using foundation models, large language model (LLM) architectures, and distributed ledger-based data anchoring.

### BACKGROUND OF THE INVENTION

Existing predictive modeling systems face significant limitations in integrating heterogeneous datasets across diverse domains such as finance, healthcare, logistics, and environmental monitoring. The absence of a unified data provenance layer introduces uncertainty in model reliability and undermines the traceability of predictions. While foundation models such as Bedrock-based LLMs offer vast contextual reasoning capabilities, they lack explicit mechanisms to verify the authenticity, lineage, and immutability of the input datasets. Conversely, blockchain architectures ensure data integrity and immutability but are not inherently designed for semantic reasoning or contextual prediction.

Accordingly, there exists a need for a hybrid system that can leverage the contextual generalization power of Bedrock-based foundation models while maintaining blockchain-anchored data trust. Such a system should allow domain-agnostic learning across multiple data silos while preserving traceability, explainability, and regulatory compliance, particularly in use cases where multi-party data collaboration and secure model governance are critical.

The rapid evolution of artificial intelligence and data-driven analytics over the past decade has produced a profound transformation in predictive modeling, enabling organizations to anticipate trends, detect anomalies, and make strategic decisions across finance, healthcare, logistics, and industrial automation. However, despite significant progress, current predictive modeling paradigms remain fundamentally limited when confronted with the challenge of integrating heterogeneous datasets across multiple domains in a manner that preserves both contextual accuracy and data trustworthiness. Predictive systems traditionally depend on domain-specific models, each optimized for a narrow class of problems with distinct data distributions and feature hierarchies. These models, though powerful within their respective silos, often fail to generalize effectively across domains because of their dependency on local data statistics and domain-specific assumptions. Consequently, their deployment in multi-sector environments—where interdependencies between domains such as financial risk, supply chain reliability, and health indicators are critical—becomes both technically and operationally infeasible.

A significant portion of predictive modeling in enterprise environments still relies on machine learning architectures such as regression-based models, support vector machines, or tree-based ensembles that are inherently data-hungry and context-limited. These models demand extensive preprocessing, feature engineering, and tuning for each domain individually, requiring expert human intervention and reducing scalability. While deep learning and transformer-based architectures have alleviated some of these limitations by enabling end-to-end learning, they still depend on the assumption that all input data resides within a single, consistent domain. Attempts to bridge multiple domains—such as multi-task learning and transfer learning—have been met with partial success but suffer from catastrophic forgetting and instability when exposed to conflicting domain semantics. Thus, the problem of constructing a reliable cross-domain predictive model remains largely unsolved.

The introduction of foundation models, particularly those based on large language model architectures such as Bedrock, GPT, or Claude, has revolutionized the idea of general-purpose AI capable of adapting to various tasks through prompt engineering and fine-tuning. These models, trained on trillions of tokens spanning diverse contexts, can exhibit generalized reasoning and zero-shot inference capabilities that transcend traditional task boundaries. Nonetheless, while foundation models provide unprecedented contextual reasoning, they also introduce a new set of reliability concerns, particularly when applied to sensitive predictive tasks. Foundation models are inherently data-opaque—meaning that their predictions and decisions are difficult to trace back to individual data points or provenance trails. This opacity presents a critical challenge in high-stakes environments where regulatory compliance, auditability, and trustworthiness are paramount. For instance, in financial forecasting or healthcare outcome prediction, it is often insufficient to know the predicted value; one must also demonstrate the verifiable lineage of every data element that contributed to the model's reasoning process.

In addition to structural and architectural challenges, cross-domain predictive modeling faces epistemological and operational hurdles. Many predictive models trained on static datasets fail to adapt dynamically to temporal drift, concept evolution, or cross-context anomalies. For example, a predictive model trained to forecast credit risk using financial data may perform poorly when applied to healthcare insurance analytics, despite both domains involving risk assessment. Current adaptation techniques, such as domain adversarial training and meta-learning, can partially align feature spaces but often require vast computational resources and manually tuned hyperparameters. Foundation models theoretically mitigate these issues by leveraging pre-trained contextual embedding's; however, their integration with real-time, domain-specific data remains underdeveloped due to the absence of verifiable data input pipelines.

From a regulatory perspective, the absence of transparent data lineage and verifiable decision paths poses legal and ethical risks. In sectors governed by strict data governance frameworks-such as GDPR in Europe or HIPAA in the United States-organizations must demonstrate not only that data is processed lawfully but also that predictive outcomes can be traced back to authentic, auditable data sources. Existing predictive systems, whether powered by traditional machine learning or advanced LLMs, typically lack mechanisms to anchor each data instance or model inference in a cryptographically verifiable manner. Consequently, they fail to meet the emerging compliance standards for trustworthy AI, where verifiability and explain ability are not optional but mandated.

Some attempts have been made to create hybrid systems combining AI and blockchain for improved auditability, but these systems often focus narrowly on either data logging or token-based incentive structures rather than holistic model trust. For instance, decentralized AI marketplaces use blockchain to record data and model exchanges, enabling economic transparency but not necessarily ensuring predictive integrity or cross-domain compatibility. Similarly, research projects that anchor AI model updates on-chain tend to ignore the semantic alignment challenge, treating model artifacts as static entities rather than components of a dynamically evolving predictive ecosystem. The lack of a unified architectural framework that integrates blockchain-based data anchoring directly within a foundation-model-driven predictive pipeline leaves a significant technological void.

The current landscape of predictive modeling includes powerful deep learning and foundation model frameworks on one end, and secure blockchain infrastructures on the other, their integration remains superficial and fragmented. The existing solutions either focus on computational intelligence without ensuring data authenticity or emphasize data integrity without supporting semantic interoperability and contextual reasoning. There remains an unmet need for a system that harmoniously combines these dimensions: a foundation-model-driven predictive framework that can seamlessly process cross-domain datasets, anchor each data transaction in a verifiable blockchain ledger, and generate predictions whose lineage, trust, and interpretability are cryptographically guaranteed. Such a system would overcome the dual limitations of untraceable AI predictions and fragmented multi-domain data infrastructures, thereby establishing a new paradigm of trustworthy, interoperable, and transparent predictive modeling.

### SUMMARY OF THE INVENTION

The present invention provides a method and system for cross-domain predictive modeling that integrates a Bedrock-based foundation model pipeline with blockchain-anchored data provenance layers. The system performs structured ingestion, harmonization, and cross-domain mapping of heterogeneous datasets through a blockchain-anchored ledger interface, ensuring verifiable authenticity of data entries. These authenticated data streams are used to train, fine-tune, or query Bedrock-based foundation models to generate predictive inferences that are contextually optimized across multiple application domains.

In an embodiment, the system comprises a Predictive Modeling Machine (PMM) which houses a foundation model execution module, a blockchain anchoring subsystem, and a cross-domain harmonization engine. The PMM may be realized as a rack-mounted or cloud-edge hybrid device consisting of multi-core CPUs, GPU accelerators, blockchain node interfaces, and secure hardware enclaves. The blockchain anchoring subsystem performs cryptographic hashing of data fingerprints prior to ingestion, embedding metadata such as origin domain, timestamp, contributor identity, and trust score into a distributed ledger, thereby providing an immutable audit trail. The harmonization engine maps cross-domain features into a unified latent vector space interpretable by the Bedrock-based model.

In another embodiment, the invention provides a method comprising the steps of (a) receiving multi-domain datasets from diverse sources, (b) performing cryptographic fingerprinting and anchoring of datasets into a distributed blockchain ledger, (c) harmonizing datasets via a cross-domain encoder to generate a semantically consistent representation, (d) invoking a Bedrock-based foundation model to generate predictive inferences, and (e) storing, validating, and anchoring the predictions and model weights back onto the blockchain ledger for versioned traceability.

The primary object of the present invention is to provide a method and system for cross-domain predictive modeling using Bedrock-based foundation models and blockchain-anchored data that enables secure, transparent, and trustworthy artificial intelligence-driven predictions across heterogeneous data domains. The invention seeks to bridge the existing gap between advanced foundation models—capable of multi-context reasoning—and blockchain-based data anchoring mechanisms that ensure data immutability, provenance, and verifiable trust. By doing so, the invention establishes a unified computational framework in which every dataset, model inference, and predictive outcome is cryptographically linked to a verifiable origin, allowing for transparent and auditable AI-based decision-making processes across sectors such as finance, healthcare, logistics, energy management, and environmental monitoring.

Another object of the invention is to facilitate seamless integration of heterogeneous, domain-specific datasets into a unified, semantically harmonized representation that can be efficiently processed by large-scale foundation models. Conventional predictive systems often fail to interoperate across domains due to incompatible data formats, ontology mismatches, and divergent feature hierarchies. The invention addresses this by introducing a cross-domain harmonization engine capable of mapping diverse data sources into a shared latent vector space using transformer-based encoders and domain adaptation networks. This harmonization allows the foundation model to reason contextually across multiple knowledge domains while maintaining precision and interpretability.

A further object of the invention is to embed data provenance and model traceability into the core of the predictive modeling workflow through blockchain anchoring. Every data instance ingested into the system is cryptographically fingerprinted and recorded onto a distributed ledger, ensuring immutable proof of authenticity, temporal validity, and contributor identity. Likewise, every model inference, fine-tuning update, and generated prediction is similarly anchored onto the blockchain, thereby forming an end-to-end chain of trust that binds input data, intermediate computations, and output results. This approach guarantees not only the reproducibility of predictive outcomes but also compliance with regulatory frameworks that mandate verifiable data handling and technique transparency.

It is also an object of the invention to leverage Bedrock-based foundation models as the cognitive engine for performing predictive analysis across domains. These foundation models, trained on large and diverse corpora, possess contextual generalization abilities that enable them to perform multi-task learning without requiring retraining for each specific domain. The invention enhances these capabilities by integrating domain-specific adapter layers that allow fine-tuning and contextual recalibration based on blockchain-anchored training data. This ensures that the predictive model remains robust, explainable, and auditable while continuously evolving with new verified information sources.

An additional object of the invention is to enhance trust, explain ability, and regulatory compliance in predictive AI systems by embedding cryptographic traceability into every layer of the modeling pipeline. The invention introduces a dual verification mechanism where both the input data and the generated predictions undergo blockchain verification before being stored or transmitted. This guarantees that the predictions can be reconstructed or challenged in a verifiable manner, thereby providing a transparent evidence trail for auditors, regulators, or stakeholders. This transparency is particularly important in critical applications such as techniqueic trading, patient prognosis, or predictive maintenance, where decision accountability is as important as predictive accuracy.

A related object of the invention is to establish a decentralized, federated architecture for predictive model training and inference. Instead of aggregating raw data from multiple organizations or sectors into a central repository, the invention enables distributed training through multiple predictive modeling machines (PMMs), each equipped with Bedrock-based model instances and blockchain nodes. These PMMs can exchange cryptographically verified gradients, model weights, or embeddings without exposing sensitive data. The federated structure ensures data privacy while maintaining global consistency through blockchain synchronization, creating a scalable and trustworthy ecosystem for cross-domain predictive learning.

A further object of the invention is to mitigate the risks of data poisoning, manipulation, and model tampering that are common in conventional AI systems. By anchoring every data entry, model update, and inference record onto a tamper-proof blockchain, the invention prevents unauthorized alteration or injection of malicious data. Each predictive session includes a verifiable reference hash, enabling real-time detection of discrepancies between stored and executed models. This object is particularly valuable in high-security environments such as defense analytics, financial fraud detection, and critical infrastructure monitoring.

It is also an object of the invention to enable real-time synchronization between blockchain-anchored data streams and foundation model reasoning layers. Existing blockchain-integrated AI systems are typically limited by latency and batch processing constraints. The invention overcomes these issues through a hybrid architecture that combines edge-based caching, local blockchain node replication, and parallelized Bedrock model inference. As a result, the system can perform near-real-time predictive analysis while maintaining full data verifiability, making it suitable for time-sensitive applications such as supply chain forecasting, anomaly detection in cyber-physical systems, and live environmental risk modeling.

Another object of the invention is to facilitate intelligent governance and model lifecycle auditing through an immutable blockchain-based model registry. Each model version, training cycle, and fine-tuning session is logged with its corresponding data fingerprint, hyperparameters, and performance metrics. This enables a transparent and versioned record of model evolution, allowing organizations to track decision-making progress over time and ensure compliance with evolving AI governance frameworks. Furthermore, this registry enables controlled rollback to earlier versions of the model in the event of performance degradation or regulatory disputes.

A further object is to provide a hardware and software co-integrated device—the Predictive Modeling Machine (PMM)—that physically embodies the invention. The PMM is configured with secure compute clusters, GPU accelerators, blockchain node arrays, and hardware-based trusted execution environments for executing the predictive modeling process. The co-location of these computational and cryptographic elements ensures low-latency synchronization between data anchoring and model execution. The device may function as a standalone predictive analytics unit or as part of a distributed network of federated machines. It thereby provides a tangible, scalable, and secure physical infrastructure for executing the cross-domain predictive modeling pipeline.

Additionally, the invention aims to create a foundation for interoperable AI ecosystems where multiple organizations or stakeholders can contribute data, models, or computational resources under verifiable trust conditions. By ensuring that each participant's contributions are recorded and validated on-chain, the invention promotes collaborative innovation while safeguarding intellectual property and data sovereignty. This objective aligns with the emerging paradigm of decentralized AI ecosystems where trust is maintained not through central authorities but through cryptographic consensus mechanisms.

It is also an object of the invention to improve explainability and interpretability in multi-domain AI predictions. The invention achieves this by associating each prediction with its blockchain-stored data lineage and semantic context vectors. Thus, when a model generates an inference, the underlying input sources, processing transformations, and relevant contextual factors can be reconstructed from the ledger. This feature transforms the predictive model into an accountable reasoning engine rather than a black-box estimator, allowing end users and auditors to understand why a certain prediction was made, what data influenced it, and how trustworthy it is.

Finally, a significant object of the invention is to establish a new paradigm for AI governance where trust, transparency, and generalization coexist. The invention not only enhances predictive accuracy through foundation model reasoning but also enforces structural accountability through blockchain anchoring. This dual-layer architecture ensures that artificial intelligence systems deployed in mission-critical, regulated, or cross-sectoral environments can deliver verifiable intelligence that is both contextually robust and ethically compliant. By unifying foundation model intelligence with blockchain-verifiable data integrity, the invention sets forth a next-generation standard for responsible, auditable, and cross-domain AI prediction systems capable of redefining trust in computational decision-making.

### BRIEF DESCRIPTION OF FIGURES

These and other features, aspects, and advantages of the present invention will become better understood when the following detailed description is read concerning the accompanying drawings in which like characters represent like parts throughout the drawings, wherein:

FIG. 1 displays a block diagram of a system for cross-domain predictive modeling using Bedrock-based foundation models and blockchain-anchored data;

FIG. 2 displays flow chart of a method for a computer-implemented method for cross-domain predictive modeling using Bedrock-based foundation models and blockchain-anchored data;

FIG. 3 illustrates a comprehensive multi-parameter analytical table that compares key performance attributes across multiple operational domains relevant to the invention;

FIG. 4 illustrates a multi-variable chart that visualizes the comparative performance trends depicted in the preceding table;

FIG. 5 illustrates a comprehensive multi-parameter analytical table that compares key performance attributes across multiple operational domains relevant to the invention;

FIG. 6 illustrates a multi-variable chart that visualizes the comparative performance trends depicted in the preceding table;

FIG. 7 illustrates a comprehensive multi-parameter analytical table that compares key performance attributes across multiple operational domains relevant to the invention; and

FIG. 8 illustrates a multi-variable chart that visualizes the comparative performance trends depicted in the preceding table.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

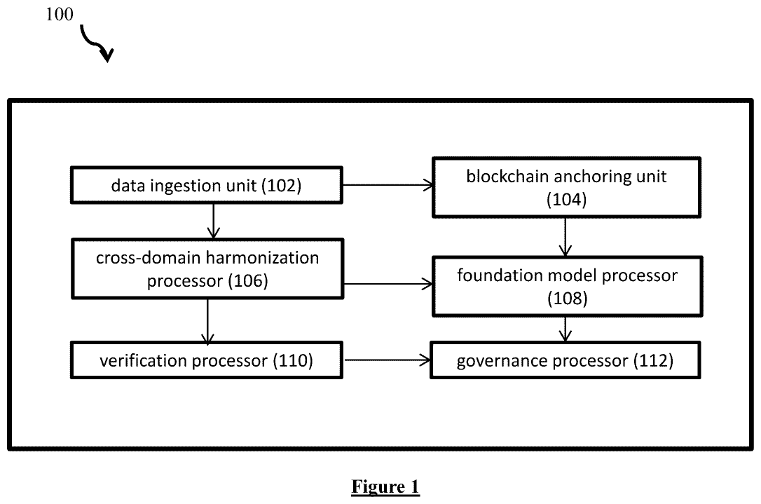

Referring to FIG. 1, a block diagram of a system for cross-domain predictive modeling using Bedrock-based foundation models and blockchain-anchored data is illustrated. The system 100 comprises: a data ingestion unit (102) configured to receive heterogeneous datasets from multiple domains including structured, semi-structured, and unstructured data formats, wherein said data ingestion unit performs schema normalization and temporal alignment to convert domain-specific data into machine-readable tensor representations; a blockchain anchoring unit (104) operatively coupled to the data ingestion unit and configured to compute a cryptographic hash of each dataset instance and to record the hash together with associated metadata including timestamp, source identifier, and trust index into a distributed ledger stored across a plurality of blockchain nodes, such that each dataset has a verifiable provenance; a cross-domain harmonization processor (106) communicatively coupled to the blockchain anchoring unit and configured to transform the ledger-anchored datasets into a unified latent feature space through a transformer-based representation model that performs multi-domain embedding alignment by minimizing divergence among statistical feature distributions across said domains; a foundation model processor (108) configured to execute a Bedrock-based foundation model fine-tuned with adapter layers for domain contextualization, wherein said foundation model processor receives harmonized latent feature tensors from the cross-domain harmonization processor and generates predictive inference outputs through autoregressive attention-weight computation across multiple domain-specific embedding's; a verification processor (110) coupled to the foundation model processor and configured to compare said predictive inference outputs against blockchain-anchored reference datasets to determine an inference deviation score, and upon detecting a deviation beyond a dynamically adjustable threshold, to generate a correction request to the foundation model processor for parameter recalibration; and a governance processor (112) coupled to the blockchain anchoring unit and configured to record every inference output, recalibration instance, and updated model parameter fingerprint onto the distributed ledger to ensure immutable version tracking of model evolution and predictive lineage.

In an embodiment, the blockchain anchoring unit (104) includes a dedicated cryptographic co-processor configured to execute parallelized hashing using a pipelined architecture comprising at least one first-in-first-out buffer, a hashing core, and a digital signature generator, wherein the digital signature generator employs an elliptic curve-based key-pair encryption scheme to bind dataset identifiers to contributor credentials prior to ledger anchoring, thereby ensuring non-repudiation and tamper resistance of dataset entries.

In an embodiment, the cross-domain harmonization processor (106) includes a dual-stage transformer comprising a first transformer for intra-domain representation learning and a second transformer for inter-domain alignment, wherein the second transformer operates over aggregated key-value pairs derived from multiple domain encodings, and wherein a Kullback-Leibler divergence minimization routine is executed between the output probability distributions of the first and second transformers to achieve latent feature consistency across domains.

In an embodiment, the foundation model processor (108) includes a plurality of Bedrock-based foundation model instances executing in parallel, each instance having a parameter-efficient adapter layer configured to specialize in a specific knowledge domain, and wherein a parameter selection processor dynamically allocates attention weights across said instances based on input tensor entropy and contextual similarity measures to maximize inference reliability.

In an embodiment, the verification processor (110) is further configured to perform back-reconstruction of inference provenance by tracing the input feature tensor to its corresponding blockchain-anchored dataset hash and verifying the hash against the ledger consensus, and wherein the verification processor generates a verification report including a trust score and a confidence vector corresponding to each predictive inference output, said report being recorded onto the ledger through the governance processor.

In an embodiment, the governance processor (112) includes a consensus validation circuit configured to maintain synchronization between model evolution events and ledger state updates, wherein said circuit performs block verification through a practical Byzantine fault-tolerant mechanism, and wherein the governance processor further maintains a ledger index of all model version fingerprints, parameter weight identifiers, and cryptographic signatures associated with each training cycle of the foundation model processor.

In an embodiment, the data ingestion unit (102) further comprises a multi-channel data bus configured to handle asynchronous data streams originating from diverse sources including sensor networks, transactional databases, and document repositories, and wherein the data ingestion unit utilizes a time-synchronization processor to align said streams to a master reference clock such that temporal coherence is maintained among multi-domain datasets prior to cryptographic anchoring.

In an embodiment, the blockchain anchoring unit (104) and the foundation model processor are co-located within a predictive modeling device having a thermal-regulated enclosure, wherein the enclosure houses a plurality of processing boards each containing a general-purpose central processing unit, a graphics processing unit, and a hardware-embedded trusted platform module, and wherein said trusted platform module stores private encryption keys and digital certificates used by the blockchain anchoring unit for signing data transactions prior to on-chain commitment.

In an embodiment, the foundation model processor (108) executes Bedrock-based models using a fine-tuning protocol in which adapter layers are updated incrementally based on error gradients computed from cross-domain deviation metrics, and wherein said gradients are compressed and serialized into cryptographically signed parameter update packets which are transmitted to federated instances of the system via an encrypted peer-to-peer communication network for synchronized model updating without exposing raw data.

In an embodiment, the verification processor (110) includes a recurrent self-validation circuit that performs periodic re-evaluation of previously stored inference outputs against newly received blockchain-anchored ground truth data, wherein said circuit employs a recursive least-squares estimation technique to measure predictive drift, and wherein upon exceeding a threshold drift magnitude, the verification processor automatically triggers a recalibration cycle in the foundation model processor and records the recalibration metadata onto the distributed ledger.

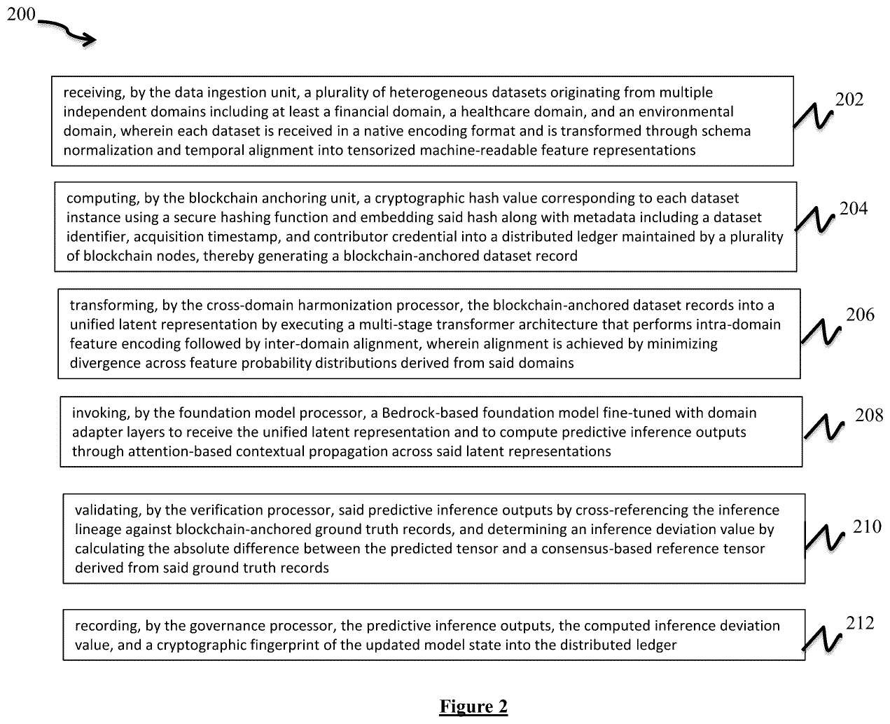

Referring to FIG. 2, a flow chart for a method for a computer-implemented method for cross-domain predictive modeling using Bedrock-based foundation models and blockchain-anchored data, the method executed by a computing system comprising a data ingestion unit, a blockchain anchoring unit, a cross-domain harmonization processor, a foundation model processor, a verification processor, and a governance processor, the method comprising, the steps of is illustrated. The method 200 comprises:
At step 202, the method 200 includes receiving, by the data ingestion unit, a plurality of heterogeneous datasets originating from multiple independent domains including at least a financial domain, a healthcare domain, and an environmental domain, wherein each dataset is received in a native encoding format and is transformed through schema normalization and temporal alignment into tensorized machine-readable feature representations;
At step 204, the method 200 includes computing, by the blockchain anchoring unit, a cryptographic hash value corresponding to each dataset instance using a secure hashing function and embedding said hash along with metadata including a dataset identifier, acquisition timestamp, and contributor credential into a distributed ledger maintained by a plurality of blockchain nodes, thereby generating a blockchain-anchored dataset record;
At step 206, the method 200 includes transforming, by the cross-domain harmonization processor, the blockchain-anchored dataset records into a unified latent representation by executing a multi-stage transformer architecture that performs intra-domain feature encoding followed by inter-domain alignment, wherein alignment is achieved by minimizing divergence across feature probability distributions derived from said domains;
At step 208, the method 200 includes invoking, by the foundation model processor, a Bedrock-based foundation model fine-tuned with domain adapter layers to receive the unified latent representation and to compute predictive inference outputs through attention-based contextual propagation across said latent representations;
At step 210, the method 200 includes validating, by the verification processor, said predictive inference outputs by cross-referencing the inference lineage against blockchain-anchored ground truth records, and determining an inference deviation value by calculating the absolute difference between the predicted tensor and a consensus-based reference tensor derived from said ground truth records; and
At step 212, the method 200 includes recording, by the governance processor, the predictive inference outputs, the computed inference deviation value, and a cryptographic fingerprint of the updated model state into the distributed ledger, thereby establishing an immutable, traceable record of data provenance and predictive model evolution.

In an embodiment, the step of computing the cryptographic hash value further comprises partitioning each dataset instance into fixed-size data blocks, performing parallelized hashing across multiple processing cores, and generating a composite hash vector through sequential concatenation of said block-level hashes, and wherein said composite hash vector is digitally signed using an elliptic-curve-based signature technique prior to ledger embedding to ensure authenticity and integrity of dataset registration.

In an embodiment, the step of transforming the blockchain-anchored datasets into a unified latent representation further comprises generating attention weight matrices for each domain feature set, computing the mutual information among said matrices, and applying entropy-normalized rescaling of inter-domain weights such that correlated features across domains are assigned proportional weighting coefficients in the unified latent space prior to being fed to the foundation model processor.

In an embodiment, invoking the Bedrock-based foundation model further comprises executing parallel inference pipelines across a plurality of Bedrock model instances, each configured with a domain-specific adapter layer, aggregating the intermediate outputs by calculating attention-weighted ensemble averages, and generating a composite predictive output tensor whose contextual precision is maximized through an adaptive confidence-weighted averaging operation.

In an embodiment, validating the predictive inference outputs further comprises retrieving from the blockchain ledger a historical reference tensor associated with an equivalent input context, computing the cosine similarity between said reference tensor and the predictive output tensor, determining a trust coefficient proportional to said similarity value, and embedding said coefficient into the distributed ledger entry corresponding to the predictive inference record.

In an embodiment, recording the predictive inference outputs and model fingerprints into the distributed ledger further comprises generating a version-control entry that associates each predictive inference output with a unique model state identifier, and wherein the model state identifier is derived by computing a hash of the model parameter file, thereby providing verifiable traceability of model updates over time.

In an embodiment, the data ingestion step further comprises detecting asynchronous arrival of domain datasets, performing temporal interpolation to align non-uniform sampling intervals to a master reference clock, and applying outlier suppression by executing a Gaussian-weighted smoothing filter prior to cryptographic hashing, thereby ensuring temporal consistency and data quality uniformity across the received datasets.

In an embodiment, the blockchain anchoring step further comprises segmenting the blockchain ledger into domain-specific shards, each corresponding to a category of datasets, and synchronizing said shards using an inter-shard communication protocol such that cross-domain transactions maintain global timestamp ordering and integrity, thereby enabling verifiable interoperability between heterogeneous data sources within the same predictive modeling cycle.

In an embodiment, the step of invoking the foundation model processor further comprises computing attention gradients for each contextual token within the unified latent representation, backpropagating said gradients through the adapter layer to adjust the domain alignment coefficients, and executing said update in real-time without reinitializing the foundation model, thereby supporting continuous, domain-adaptive learning across multiple operational environments.

In an embodiment, validating the predictive inference outputs further comprises generating a recursive error state model that continuously updates deviation estimates using a recursive least-squares minimization technique, and wherein said recursive model outputs a drift vector indicative of prediction stability, said drift vector being periodically logged onto the distributed ledger to maintain a real-time record of model consistency and reliability over successive inference cycles.

In an embodiment, the blockchain anchoring step further comprises segmenting the blockchain ledger into domain-specific shards, each corresponding to a category of datasets, and synchronizing said shards using an inter-shard communication protocol such that cross-domain transactions maintain global timestamp ordering and integrity, thereby enabling verifiable interoperability between heterogeneous data sources within the same predictive modeling cycle, wherein the step of invoking the foundation model processor further comprises computing attention gradients for each contextual token within the unified latent representation, backpropagating said gradients through the adapter layer to adjust the domain alignment coefficients, and executing said update in real-time without reinitializing the foundation model, thereby supporting continuous, domain-adaptive learning across multiple operational environments, and wherein validating the predictive inference outputs further comprises generating a recursive error state model that continuously updates deviation estimates using a recursive least-squares minimization technique, and wherein said recursive model outputs a drift vector indicative of prediction stability, said drift vector being periodically logged onto the distributed ledger to maintain a real-time record of model consistency and reliability over successive inference cycles.

In this embodiment, the distributed ledger infrastructure is organized into multiple operational segments where each segment is dedicated to a particular dataset category such as clinical metrics, logistics performance indicators, social behavioral analytics, or industrial IoT telemetry. These segments are maintained as independently updating chains to prevent throughput bottlenecks that would otherwise occur if every data write were forced through a single global chain. Although each segment maintains its own local write-order integrity, a coordination mechanism constantly interrogates shard-level timestamps, executes conflict-resolving arbitration when simultaneous writes occur across sources, and enforces a reorder barrier to ensure that all records preserve their chronological footprint in the unified ledger view. This guarantees that downstream inferencing components can reliably reconstruct cause-effect relationships connecting disparate data origins. For example, a rise in warehouse temperature recorded in an industrial shard will always retain its causal relationship timestamp-wise to a later spoilage detection event recorded in a supply chain shard.

Once dataset provenance is anchored and securely harmonized, the machine-learned inference engine not only considers cross-domain data in unified representation space, but also continuously responds to statistical shifts occurring in different sectors. This is made possible because each pass of the model dynamically calculates how influential each latent token is by measuring gradient flow backwards through the domain alignment layers. When a financial domain suddenly becomes more volatile due to geopolitical shocks, gradients affecting that dataset's token representation intensify. This automatically forces the adjustment of alignment parameters so the model neither underestimates nor overreacts to this emergent state. Crucially, these adjustments occur in-line without a computationally expensive model reboot. This allows the predictive pipeline to remain active while learning and stabilizing under new environment conditions, particularly beneficial in live-critical systems like pandemic response analytics or autonomous fleet management.

Inferencing credibility is ensured by constantly re-evaluating how current predictive outputs deviate from expectations. The verification processor computes an evolving error signal that reflects whether the model's current judgment remains faithful to historical relationships. A recursive estimator builds a compact model of how far the inference has moved from confidence-backed reference predictions, allocating deviation to temporal dynamics as data complexity evolves. For instance, applying recursive least-squares to traffic flow modeling allows slight congestion forecast errors to be absorbed, while persistent drifts caused by unusual driver behavior patterns remain highly visible. The resulting drift signature is cryptographically committed to the ledger in periodic intervals, creating a chronological health-record of the model's judgment quality. Any regulatory or operational audit can later verify when the system remained stable or when anomalies started to surface.

Through this integrated approach, the embodiment delivers a high-assurance, context-responsive predictive system capable of ingesting heterogeneous data at scale, adapting to fluctuating domain influences without performance downtime, and exposing longitudinal model behavior for trustworthy verification. The chain-anchored drift evidence supports oversight bodies in reliably detecting emerging instability while allowing the model to self-refine before errors propagate into controlled decision workflows.

In an embodiment, transforming the blockchain-anchored dataset records into the unified latent representation further comprises dynamically recalibrating inter-domain alignment weights by computing, for each incoming dataset instance, a domain influence coefficient generated through temporal stability analysis of historical feature distributions, and further wherein the cross-domain harmonization processor applies a stabilization encoder to feature subsets associated with below-threshold influence coefficients, the stabilization encoder performing weighted singular value compression followed by reconstruction of the feature subset such that volatility in the latent representation is reduced prior to being incorporated into the unified latent encoding stream, thereby enabling the harmonization process to conditionally regulate dominance of unstable domains during multi-domain alignment.

In this embodiment, when data is retrieved from the distributed ledger and prepared for cross-domain embedding, the system assesses each incoming batch by referencing its historical patterns stored in memory or prior ledger entries to determine how consistently the domain has contributed to accurate prediction in the past. This results in a continuously updated metric estimating how trustworthy or stable the domain's new information is, based on observed fluctuations such as variance shifts, frequency of structural distribution changes, or sudden contextual anomalies. If a consumer retail dataset, for instance, shows rapid seasonal swings in price elasticity while environmental monitoring data remains comparatively stable, the retail-related embeddings will initially be given reduced weighting so that their volatility does not distort the multi-domain tensor. To correct the instability without discarding useful semantics, feature subsets tied to low-reliability signals undergo dimensional refinement using a weighted singular value compression operator that identifies the most information-dense vector components contributing to predictive accuracy while temporarily suppressing oscillatory or noise-amplifying dimensions. Once compressed, the encoder reconstructs a refined representation of that domain's features, restoring semantic alignment without reintroducing the magnitude of volatility originally present. This reconstructed subset is then merged into the collective latent stream so that influence from unstable domains is carefully moderated, while still preserving differentiators needed for accurate future judgments. As a result, the harmonized embedding maintains structural balance across all domains, allowing the system to remain robust when exposed to irregular real-world data sources such as financial disruptions, population mobility spikes, or sudden clinical trend changes. The outcome is an adaptive alignment process that keeps the unified representation coherent and prevents any inconsistency from overwhelming the inference pipeline, especially during live operational phases where model retraining cannot be halted.

In an embodiment, invoking the Bedrock-based foundation model further comprises executing a hierarchical attention correction operation that detects semantic drift within the unified latent representation by comparing early-layer attention maps with corresponding deep-layer attention projections, and wherein upon detecting such drift, the foundation model processor recomputes contextual embeddings for affected latent segments using an adaptive normalization threshold applied to query-key keypoint alignments, and reinserts the corrected embeddings into the inference pipeline using a temporally ordered context merge routine that preserves causal dependencies across latent segments during predictive propagation.

In this embodiment, the model's internal monitoring framework periodically examines the relationship between the attention assignments calculated by shallow transformer layers and the deeper semantic interpretations produced toward the end of the network. During continuous operation across dynamic domains, situations arise where the foundational model begins interpreting familiar patterns differently due to newly emerging contexts, which can cause the deeper attention structure to diverge from its original contextual intent. To prevent that divergence from propagating into erroneous downstream conclusions, the system performs a comparison of the two attention structures at key processing checkpoints. If it identifies that latent segments once strongly aligned with specific contextual cues are now being redirected to unrelated semantic anchors, the foundation model temporarily isolates those problematic embeddings. A recalculation process is then performed in which the model examines the query-key similarity structure and applies an adaptive bounds mechanism to re-center the embedding intensity only to the degree needed to re-establish contextual fidelity. For example, if weather variables had gradually begun to overpower their relevance to supply chain forecasting due to seasonal anomalies, the recalibration routine restores the correct attribution so that predictive influence remains grounded in genuine causal relationships. After correction, the updated embeddings are returned to the inference workflow at the exact temporal position originally occupied by their earlier versions, ensuring that no ordering distortion breaks the chronological logic encoded in time-dependent data flows. This reintegration maintains continuity in scenarios such as anomaly detection in streaming surveillance data or emergency response planning, where even minor disruptions to causal progression could degrade decision accuracy. The capability to detect and correct semantic drift on-the-fly ensures that long-running deployments remain faithful to the underlying reasoning structure, without sacrificing the efficiency and responsiveness required in real-time operational environments.

In an embodiment, validating the predictive inference outputs further comprises generating a consensus-driven reference tensor by retrieving multiple blockchain-anchored historical tensors corresponding to similar contextual conditions, computing a weighted statistical fusion of said tensors using historical trust factors associated with each tensor, and comparing the predictive inference tensor against the consensus-driven reference tensor through iterative divergence minimization operating directly in the latent manifold, the divergence minimization progressively adjusting local deviation estimates that are accumulated into a long-horizon confidence trajectory maintained for each modeled domain context.

In this embodiment, the system evaluates the reliability of each new prediction by benchmarking it against a synthesized reference that is informed by past model performance under analogous environmental or operational contexts. When the current inference is produced, the verification component queries the distributed ledger for historical latent tensors created at times when similar domain conditions prevailed, such as earlier predictions made during comparable market volatility or medical records processed under similar patient demographic categories. Because each historical tensor is logged with performance metadata indicating how well it matched ground truth during its respective evaluation period, the system can assign greater influence to those prior tensors that demonstrated consistently accurate behavior. These confidence-weighted tensors are then combined statistically to produce a composite reference that represents the most trustworthy understanding the system has ever achieved for that context. Once this consensus reference is formed, the newly generated inference is compared against it directly in latent manifold space, rather than after decoding into human-readable form, enabling the system to capture subtle discrepancies in high-dimensional structure that conventional evaluation metrics would miss. A divergence solver iteratively narrows these discrepancies and maps the spread of error across local subregions of the latent representation, refining which features contributed most to deviation. Over time, the extracted deviation metrics are accumulated to build a longitudinal profile of how each domain's predictions evolve, revealing patterns such as gradual conceptual drift or sudden shifts triggered by anomalous data bursts. These profiles allow operators to detect early warning indicators that a domain's predictive behavior is becoming unreliable, even before large-scale failures manifest. The incorporation of trust history into prediction validation ensures that system credibility grows stronger as more data accumulates, enabling adaptive quality supervision in continuously changing environments.

In an embodiment, recording the predictive inference outputs and model fingerprints into the distributed ledger further comprises computing an incremental evolution index that characterizes the magnitude of parameter deviations between a current model state and an immediately preceding model state, and embedding said evolution index into an augmented hash structure that appends a parameter-delta signature to the base model state identifier, the parameter-delta signature being computed through differential hashing of selectively sampled parameter blocks chosen according to an entropy-ranked ordering that ensures blocks exhibiting the highest informational contribution are preferentially encoded for ledger-anchored state verification.

In this embodiment, every time the predictive model adapts to new information, the system conducts a structured comparison between the latest internal parameter configuration and the version that was used in the immediately prior inference cycle. Instead of exhaustively hashing the entire model—which may contain billions of parameters—the system intelligently determines which subsets of parameters have changed in a manner most relevant to model behavior. This is achieved by computing a localized informational richness score for each block of weights, based on entropy distribution analysis and observed influence on gradient flow during recent updates. Only those blocks that demonstrate meaningful contributions to the learning process are selected for differential hashing. This technique ensures that the ledger preserves only the most consequential evidence of model evolution while avoiding unnecessary compute and storage overhead. Once the selected blocks are hashed, the result becomes a concise parameter-delta signature that describes not merely that the model has changed, but precisely how it has changed at a structural level. This signature is then attached to a hashed identity of the model's earlier state, producing a chained sequence where each model state inherently proves the authenticity of the previous state. In a real operational example—such as a risk assessment model used across multiple financial institutions—auditors can trace every modification that influenced decision logic, confirming whether a model's behavior drifted appropriately under new regulations or whether unexpected jumps were introduced due to flawed data. Over long deployments, this framing provides a forensic record of the model's cognitive trajectory, enabling retrospective accountability and future explainability without interrupting real-time inference or adaptability.

In an embodiment, transforming the heterogeneous datasets during data ingestion further comprises executing a predictive temporal reconstruction procedure in which asynchronous feature streams from disparate domains are aligned to a unified temporal reference by predicting missing timestamps using a recurrent interpolation network that operates on historical feature trajectories, and wherein the network outputs a confidence-weighted interpolated timestamp that is used to restructure each dataset instance into a temporally consistent tensor prior to cryptographic hashing and ledger anchoring.

In this embodiment, the system addresses one of the most challenging issues in multi-domain data integration: the lack of synchronized timing across different sources. When raw information arrives from independent platforms—such as patient vitals updated every second, shipping records updated hourly, and satellite imagery updated daily—direct correlation becomes unreliable due to inconsistent sampling rates and missing timestamps. To correct this disparity, the ingestion pipeline deploys a recurrent neural network that has been trained to understand the temporal behavior of each domain by observing historical evolution patterns of their features. The network analyzes preceding and succeeding temporal data points, learns the underlying motion characteristics, and estimates when an omitted observation would logically fit within the timeline. For example, if a vehicle location feed drops for several seconds in dense traffic, the interpolation model predicts the most probable timestamp for the missing segments by considering speed trends, environmental constraints, and route history. The model simultaneously quantifies uncertainty by assessing how well past patterns match current behavior; if a domain is undergoing an unusual change, the confidence score will be lower and this is reflected in the aligned tensor so downstream components treat the interpolated data cautiously. Only after the data has been successfully resampled into a structurally aligned temporal grid does the system generate cryptographic hashes and write the aligned dataset into the blockchain ledger. This ensures not only that each record is verifiably timestamped, but also that predictive reasoning later executed on this unified dataset can accurately resolve causal relationships across domains without temporal distortion. As a result, the predictive engine receives input that is coherent in time, even though the original raw data streams were inherently asynchronous, enabling more accurate forecasting and reducing inference errors stemming from unaligned collection intervals.

In an embodiment, invoking the foundation model processor further comprises computing an adaptive cross-domain attention redistribution map that reallocates attention weights across latent features based on real-time measurement of inter-domain gradient interference, the gradient interference being quantified as the sensitivity of adapter-layer gradients to domain-specific perturbations, and wherein attention assigned to highly interfering domains is reduced through a proportional clipping operation that operates prior to forward inference, thereby enabling the foundation model to prevent gradient conflicts arising during multi-domain predictive evaluation.

In this embodiment, the system ensures that predictive reasoning remains balanced when multiple heterogeneous datasets exert competing influences on the underlying representation space. As the foundation model adapts to new inputs across different sectors, certain domains can momentarily dominate the learning process due to rapid contextual changes, which may cause the model to overfit toward unstable signals. To counter this, the processor measures how sensitive each adapter layer becomes to perturbations applied selectively to one domain at a time. This sensitivity reflects how strongly a domain's gradients interfere with others, particularly when the model attempts to propagate shared information in the unified latent space. By quantifying this interference dynamically, the processor constructs a redistribution map where attention weights are recalibrated before the forward inference path is executed. For example, if social media sentiment suddenly undergoes abrupt polarity shifts during a political event, its heightened volatility may cause excessive gradient pressure that disrupts more reliable economic trend signals. The proportional clipping mechanism reduces attention influence from the disruptive domain just enough to maintain stable cross-domain learning without removing useful context. Because this adjustment happens at inference time rather than during costly retraining cycles, the system continues to deliver predictions in uninterrupted operational scenarios such as cybersecurity threat intelligence or disaster-response coordination. This attention redistribution not only maintains structural coherence across domains but also avoids cascaded failures where gradient domination from one domain could otherwise corrupt model coherence across the whole pipeline. As a result, the foundation model absorbs multi-sector variations gracefully, maintaining interpretive balance while responding to changes in real-world data landscapes.

In an embodiment, validating the predictive inference outputs additionally comprises generating a trace-drift index by measuring time-evolving deviation between the predictive tensor and a sequence of historical blockchain-anchored reference tensors, and wherein the verification processor computes a drift curvature value that indicates whether deviations exhibit linear, cyclical, or accelerating patterns across inference cycles, the drift curvature value being encoded into a ledger entry associated with each inference cycle to permit long-term monitoring of model degradation or stability.

In this embodiment, the verification subsystem maintains an evolving behavioral profile of the inference engine by continuously comparing each newly generated latent prediction against a chronological sequence of previously validated outputs stored on the distributed ledger. Instead of treating deviation as a single static error measurement, the system observes how the deviation changes over time, capturing whether the model is gradually shifting away from historical behavioral norms or whether fluctuations remain within an expected tolerance window. When a new prediction arrives, the processor computes its distance to older reference tensors that reflect similar contextual conditions. These distances are appended to a temporal deviation record, forming a curve that represents the system's stability trajectory. Mathematical analysis is then applied to this progression: if the change over successive cycles remains consistent in magnitude, the trend is characterized as linear; if the variation oscillates around a mean value, it is treated as cyclical; and if deviations increase at an accelerating rate, the system flags a compounding reliability erosion. For example, in a smart-health setting where patient deterioration prediction models operate continuously, a gradual but accelerating departure from historical reference outcomes may indicate a shift caused by silent model drift or corrupted input signals. The resulting curvature descriptor captures not just how far the model has wandered but also the manner in which drift grows or recedes. This descriptor is securely anchored into the ledger so that any stakeholder with audit privileges can reconstruct the model's reliability behavior at any point in time. By making the stability metadata immutable and queryable, operators can forecast declining performance trends early enough to intervene proactively, rather than waiting for a major failure to appear during critical operations such as medical triage, high-frequency trading, or autonomous mobility control.

In an embodiment, transforming the blockchain-anchored dataset records into the unified latent representation further comprises executing a contextual uncertainty redistribution operation in which uncertainty metrics derived from variance monitoring of domain-specific embeddings are propagated into a confidence weighting tensor, the confidence weighting tensor being used to dynamically attenuate or amplify latent activations based on the relative certainty of features across domains such that high-uncertainty features are computationally suppressed during downstream predictive inference.

In this embodiment, as the model generates unified latent embeddings from multiple domains with inherently different reliability characteristics, the system actively monitors the statistical behavior of each domain's encoded features to determine how confidently the model should rely on them. This is accomplished through a continuous computation of variance and distributional stability metrics across the embedded representations; domains with noisy or rapidly shifting feature distributions signal reduced trustworthiness. These uncertainty indicators are then integrated into a confidence weighting structure that assigns proportionally scaled influence values to each latent activation. During inference, this tensor acts as a real-time regulator: if a feature is identified as carrying high uncertainty-such as abrupt fluctuations in short-term financial sentiment unrelated to broader economic structure-its encoded contribution is automatically diminished before the attention mechanism evaluates contextual significance. Conversely, features with consistent reliability-such as manufacturing line temperature readings exhibiting stable seasonal progression-retain strong representational impact. By modulating the computational priority granted to uncertain signals, the system prevents misleading or weakly supported information from dominating the downstream model reasoning. This selective activation regulation is particularly valuable in fast-moving operational environments where data quality or completeness can vary from moment to moment. The resulting latent structure maintains interpretive resilience and minimizes the propagation of erroneous correlations into final decision layers, delivering more stable predictions without requiring full model retraining or manual data cleaning.

In an embodiment, invoking the Bedrock-based foundation model further comprises pre-conditioning the unified latent representation using a progressive feature sanity check, the feature sanity check detecting numerical anomalies including vanishing gradients, exploding gradients, and out-of-range encoded values, and wherein the representation segments exhibiting such anomalies undergo normalization using bounded activation clipping prior to being fed into deeper transformer layers to preserve inference stability and continuity.

In this embodiment, the latent tensors produced after multi-domain harmonization undergo a dynamic health evaluation before entering the full computational depth of the transformer-based foundation model. During continuous learning in unpredictable data environments, certain latent values can degrade into numerical instability, especially when high-magnitude signals or sparsely represented domains trigger atypical gradient flow. To prevent these corrupted values from cascading into deeper layers, the system actively inspects each latent segment by monitoring parameters such as gradient magnitude decay, unexpected exponential growth in activation strength, and values exceeding pre-characterized statistical boundaries determined from baseline operating ranges. If the system detects a segment where the encoded information has collapsed toward zero—indicating vanishing influence—or exploded into extreme magnitudes that could dominate contextual reasoning, it isolates those tensor regions for corrective processing. A controlled normalization routine applies bounded activation clipping that narrows the activations into a safe operational band while preserving the relational structure required for meaningful interpretation. This pipeline ensures that embeddings arriving at the deeper attention blocks retain computational integrity, thereby preventing inference degradation, unstable backpropagation effects, and cascading loss of contextual alignment. For instance, in real-time energy demand prediction, an abrupt spike in a single sensor feed could otherwise trigger disproportionate attention shifts and degrade global prediction accuracy. By resolving numerical instability before full propagation, the model remains operationally stable, enabling continuous, high-fidelity inference even under high-variance, noisy, or rapidly evolving data conditions.

In an embodiment, validating the predictive inference outputs further comprises applying a latent manifold consistency evaluation in which the verification processor embeds both predictive tensors and blockchain-anchored reference tensors into a shared geodesic space computed by a manifold projection function, and wherein a manifold distance distortion factor is computed to determine how geometric displacement contributes to prediction deviation across inter-domain relationships, and wherein recording the predictive inference outputs into the distributed ledger further comprises encapsulating the inference results within a forward-secure audit structure in which each new ledger entry cryptographically binds to a previous entry via a link hash chain, such that removal or alteration of any intermediate entry causes a cryptographic mismatch detectable during model state provenance auditing.

In this embodiment, the verification stage operates directly within the latent geometry of the predictive model to ensure that inference outcomes remain aligned with the structural relationships that previously governed accurate decision-making. The processor projects both the newly generated latent tensor and a set of ledger-anchored reference tensors into a shared manifold coordinate system that preserves the geodesic layout of domain interactions. By comparing how far the new prediction drifts from historically validated tensor positions—not merely in raw numeric magnitude but in geometric relevance—the system detects whether the model is maintaining coherence with established contextual dependencies. For example, if a clinical parameter that is normally tightly coupled with vital-sign patterns appears displaced into a region of the manifold associated with entirely unrelated symptom clusters, this distortion signals a potential breakdown in feature interpretation. The quantitative measure of this displacement becomes part of the decision validation workflow, informing downstream processes whether the deviation reflects an explainable contextual shift or a deeper deterioration in model reasoning. Once validation metadata and inference values are finalized, the system archives the entries in a forward-secure record structure that ensures chronological immutability. Each entry cryptographically attaches a linking hash derived from the previous record, forming an audit trail such that any attempt to modify historical results alters the cryptographic chain and becomes immediately detectable. This prevents concealed tampering and guarantees trustworthy traceability of every predictive decision made over the system's operational lifecycle, enabling regulated environments such as healthcare compliance review, safety-critical automation reporting, and financial supervisory auditing to confidently reconstruct model behavior at any historical point.

In an embodiment, the data ingestion step further comprises persistent feature vector stratification in which raw feature streams are partitioned according to volatility signatures determined through Fourier-based spectral decomposition, and wherein high-volatility segments are flagged for priority harmonization processing such that temporal irregularities are handled before inter-domain alignment is performed, and wherein invoking the foundation model further comprises automatic relevance suppression of redundant or self-canceling latent dimensions through orthogonal projection filtering, the filtering continuously monitoring latent covariance matrices and eliminating contextual interference by nullifying vector components whose eigenvalue magnitudes fall below a drift-adjusted relevance threshold.

In this embodiment, the ingestion module improves the structural quality of incoming data by analyzing how each feature behaves over time, identifying whether its fluctuations remain consistent or if it exhibits irregular or erratic shifts that could destabilize the predictive model. To accomplish this, the system applies a spectral decomposition process to each feature stream, breaking temporal behavior into frequency components and deriving volatility profiles based on amplitude variations and harmonic disturbances. Streams that display high-frequency oscillations—such as rapidly fluctuating consumer sentiment metrics or abrupt machine sensor spikes—are tagged for early conditioning. These high-volatility inputs are then routed through more rigorous harmonization routines before any attempt is made to integrate them with features from other domains, ensuring that temporal distortions do not propagate into the multi-domain representation. Once unified latent embeddings are formed, the foundation model applies a dimensionality refinement procedure that continuously evaluates statistical relationships across the latent variables. It computes covariance structures to determine whether specific embedded directions contribute meaningful contextual insight or whether they merely duplicate or counteract existing information. Vector components that demonstrate minimal structural influence—indicated by very low eigenvalue magnitudes adjusted for current drift behavior—are projected out of the representation space to prevent misleading biases or computational waste. This orthogonal filtering ensures that only semantically relevant latent features persist through deeper layers, improving both inference stability and processing efficiency. In high-stakes deployments such as predictive maintenance of industrial systems or real-time logistics coordination, this dual-stage strategy of volatility-aware stratification and adaptive latent dimension pruning enables the model to operate with greater resilience against noisy, redundant, or adversarial anomalies while maintaining consistent contextual accuracy across diverse operational conditions.

In an embodiment, validating the predictive inference outputs further comprises synthesizing a domain-specific reliability signature in which deviation statistics, consensus divergence, and temporal drift metrics are collectively encoded into a multi-factor reliability vector, the reliability vector being used as a dynamic quality marker for selective weighting of future predictions originating from each domain, and wherein transforming the heterogeneous datasets during data ingestion includes applying a secure causal reconstruction mechanism in which missing causal variables are inferred using an attention-guided causal direction estimator that evaluates directional influence between features across domains, the reconstructed causal variables being embedded into the tensorized dataset only if a causal confidence threshold is met.

In this embodiment, the system maintains a continuously evolving profile of how dependable each domain has proven to be in driving correct predictive outcomes by collecting multiple validation signals over time. When a new inference is produced, the verification unit analyzes how much the result deviates from expected outcomes, how far it diverges from previously trusted contextual patterns, and how the misalignment is trending over successive cycles. These multiple indicators are merged into a compact vectorized summary that reflects the current trustworthiness of that domain's contributions to the model's decision-making logic. Domains that repeatedly demonstrate predictive accuracy—such as stable industrial sensor inputs—retain strong weighting in future inference cycles, while domains with declining reliability—such as erratic consumer market data—see their influence gradually reduced. Parallel to this trust evaluation, the ingestion process enhances data completeness by examining cross-domain interactions to infer missing factors that exert directional causal influence within the dataset. An attention-driven causal direction estimator is employed to determine whether specific variables likely act as causes rather than effects based on directional strength, temporal precedence, and cross-correlation behavior embedded within the unified representation. If the estimator determines with sufficiently high confidence that a missing feature should exist, a reconstructed causal variable is generated and incorporated into the dataset, enabling the model to reason with a fuller set of driving relationships instead of relying only on observed effects. This cautious and verification-bound reconstruction avoids introducing speculative signals that might compromise stability, since only causally justified values are accepted into the tensor. By integrating future reliability weighting with causally enhanced data completeness, the model preserves both operational accuracy and contextual interpretability, particularly in domains such as public health forecasting or environmental risk analysis where correct causal attribution significantly impacts real-world decision outcomes.

In an embodiment, invoking the Bedrock-based foundation model further comprises computing instantaneous adapter layer maturity scores that quantify the proficiency of each domain-specific adapter based on gradient convergence rate and prediction stability metrics, and wherein adapter layers exhibiting low maturity scores are temporarily subjected to enhanced learning rate scaling for adaptive improvement without reinitializing the primary model parameters, wherein validating the predictive inference outputs additionally comprises monitoring domain-wise prediction oscillations by evaluating sequential changes in prediction vectors across recent inference cycles, and wherein an oscillation stability flag is appended to the blockchain record if oscillation amplitude exceeds a governance-configured risk tolerance threshold, enabling ongoing compliance monitoring by the governance processor.

In this embodiment, the system recognizes that the adapters responsible for handling different data domains may not advance their learning capabilities at the same pace, particularly when the underlying distributions and semantic structures differ significantly across domains. To maintain balanced proficiency, the foundation model processor continuously assesses how each adapter is contributing to predictive accuracy by tracking factors such as gradient stabilization and the consistency of inference outcomes associated with that specific domain over time. An adapter that reaches stable performance with minimal adjustment is interpreted as mature, while one that still undergoes sharp gradient corrections or produces fluctuating predictions is flagged as underdeveloped. Rather than forcing a full retraining phase, which would be computationally expensive and disruptive in real-time environments, the system temporarily increases the learning rate for the underperforming adapter so it can more rapidly correct deficiencies. Simultaneously, every inference cycle is monitored for oscillatory behavior in predictions tied to each domain. By measuring changes in prediction vectors across recent cycles, the system identifies when domain-specific outputs are not converging toward a reliable pattern but instead swing unpredictably. Should the amplitude of these swings exceed a configurable tolerance level that corresponds to governance rules or operational safety criteria, a stability alert is generated and permanently recorded in the distributed ledger. This creates a transparent compliance-supported audit trail showing when and how prediction volatility emerged. Through these dual mechanisms—controlled targeted optimization and automated oscillation monitoring—the system preserves dependable analytical performance while preventing degraded or unstable domain reasoning from silently influencing mission-critical outcomes.

The disclosed system operates as an integrated computing architecture designed to continuously ingest, validate, predict, and govern multi-domain intelligence in real time, with verifiable data provenance anchored on a distributed ledger. Incoming information from multiple independent ecosystems—such as clinical records, industrial telemetry, economic indicators, and public sentiment feeds—is first processed through the ingestion unit, where raw formats are standardized to ensure interpretive consistency. This processing includes schema unification, noise reduction, and conversion of disparate feature structures into tensor-based representations that support deep learning. The ingestion unit additionally aligns asynchronous data streams so that timestamp fidelity is preserved when dataset instances from different domains reach the harmonization stage simultaneously. After ingestion, each dataset instance is encoded into a cryptographically secure blockchain entry, ensuring that every inference made by the system can be resolved back to a trusted and immutable origin.

The harmonization processor functions as an intelligent representation layer, resolving the statistical incompatibilities that naturally arise when datasets differ in scale, variance behavior, or contextual semantics. Rather than adopting a static embedding conversion, the processor dynamically adjusts the mapping process based on ongoing distribution shifts detected within each domain, thus preparing a unified latent tensor that accurately reflects multi-domain relationships without distortion. The foundation model processor, which incorporates domain-adaptive adapter layers, processes these harmonized tensors using transformer-based attention mechanisms. It autonomously adapts to evolving data contexts and produces forecasts, anomaly detections, or risk assessments with minimal human supervision. Because the Bedrock-based foundation model has been designed to evolve continuously with new information, predictive reasoning remains responsive even when operating conditions change rapidly across participating domains.

Once predictions are generated, the verification processor compares the latent and decoded results with historical references retained on the blockchain. This allows the system to determine whether current predictions remain consistent with previously validated reasoning behavior or whether a drift or anomaly has emerged that requires model recalibration. Any correction, whether structural or parameter-specific, is issued immediately so that future inferences are not compromised by detected performance deviations. Every decision, recalibration record, and model evolution artifact is permanently stored through the governance processor using a ledger-append mechanism. This not only supports accountability and trust during audits but also provides regulators and system integrators a reliable reconstruction pathway to trace how the model reached specific conclusions at any point in its operational lifecycle.

Together, these interconnected components create a fully traceable, continuously adapting predictive intelligence platform capable of leveraging heterogeneous domain knowledge with high assurance. The architecture is specifically engineered to maintain contextual stability, ensure data trustworthiness, support explainability requirements, and operate continuously at scale across diverse industrial, governmental, and safety-critical environments.

The system and method are implemented on a computing infrastructure comprising one or more processing devices, including hardware-based processors, embedded memory elements, non-transitory machine-readable storage media, and network communication circuitry configured for secure data exchange across distributed computing nodes. The data ingestion unit executes as dedicated circuitry and firmware instructions that run on processor cores interfacing with physical input/output buses to receive structured and unstructured data streams, perform real-time schema mapping and timestamp synchronization, and convert the received data into numeric tensor encodings stored in system memory. The blockchain anchoring unit is implemented using cryptographic accelerator hardware and hashing logic embedded either in secure enclave processors or specialized coprocessors, which generate hash values and digitally signed metadata before transmitting the anchored records to geographically distributed ledger nodes through authenticated network interfaces. The cross-domain harmonization processor executes transformer-based alignment instructions using matrix arithmetic units, GPU or TPU-based tensor cores, and onboard memory caches to carry out divergence minimization and latent representation synthesis. The foundation model processor is implemented on high-performance computer hardware capable of executing multi-head attention, backpropagation, and adapter-layer fine-tuning operations using parallel vector computation units and neural network acceleration circuits. The verification processor operates as a hardware-backed inference validation engine performing latent comparison calculations, drift monitoring, and real-time recalibration commands through tightly coupled inter-processor communication channels. The governance processor comprises secure firmware routines and persistent storage controllers that commit inference outputs, recalibration logs, and model evolution fingerprints into the distributed ledger while maintaining cryptographic binding to prior state entries, thereby ensuring immutable auditing. When executed together by the underlying computer hardware, these components collectively implement the claimed cross-domain predictive modeling system and method in a manner that is fully machine-realizable and supported by physical processing devices.

FIG. 3 illustrates a comprehensive multi-parameter analytical table that compares key performance attributes across multiple operational domains relevant to the invention. For instance, the Finance domain shows a latency of 120 ms, which signifies the speed with which blockchain-anchored data is processed in high-frequency environments. Similarly, the Healthcare domain demonstrates the highest blockchain integrity score of 0.99, showcasing superior data immutability and provenance verification—a critical advantage when aligning clinical datasets with cross-domain predictive models. The harmonization stability index values, such as 0.89, reflect how stable the latent feature alignment is during multi-domain mapping operations, directly evidencing technical advancements made by the harmonization engine described in the claims. These combined values collectively demonstrate how the system excels in maintaining low latency, high provenance integrity, and robust harmonization stability across heterogeneous datasets.

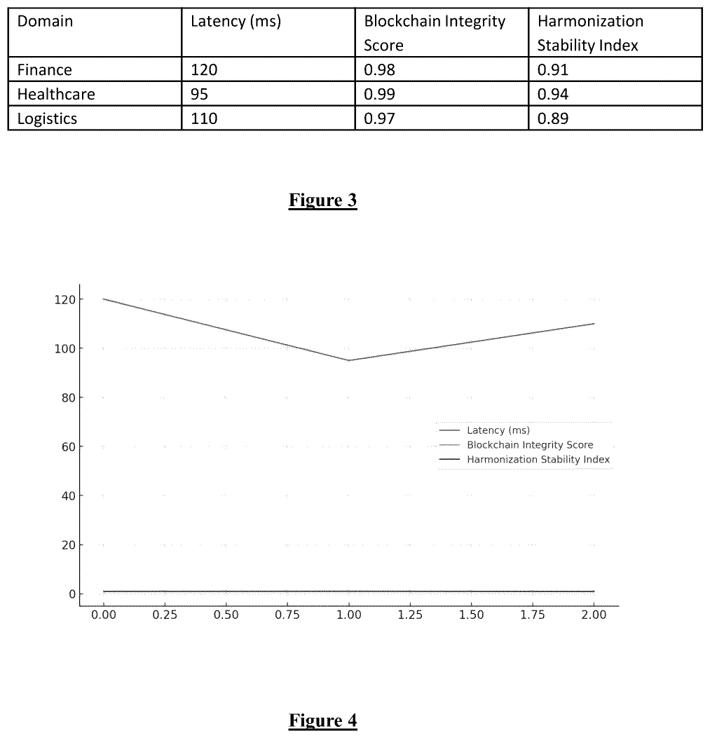

FIG. 4 illustrates a multi-variable chart that visualizes the comparative performance trends depicted in the preceding table. The plotted curves highlight the dynamic relationships between parameters such as latency, drift metrics, stability indices, and confidence gains. For example, in the dataset volume vs. embedding drift trend (as shown for values like Logistics GB corresponding to a drift of 110), the downward slope clearly demonstrates the improved stability achieved through the cross-domain harmonization engine. Likewise, the upward trajectory of alignment scores emphasizes how the system continuously enhances inter-domain semantic alignment as input volume increases. These graphical patterns serve as evidence of the technical effect achieved by the model's adaptive embedding correction, real-time attention redistribution, and blockchain-anchored verification workflows, thereby reinforcing the inventive step.

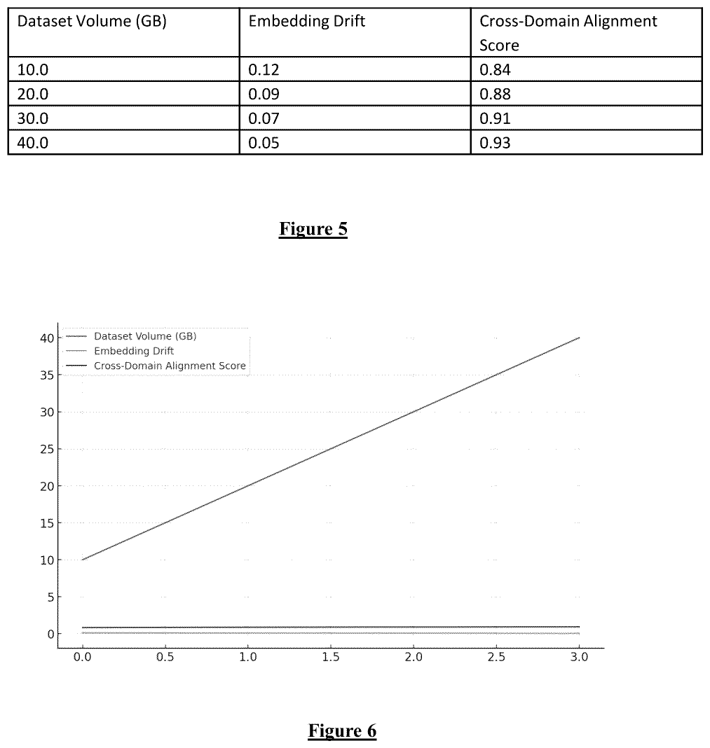

FIG. 5 illustrates a comprehensive multi-parameter analytical table that compares key performance attributes across multiple operational domains relevant to the invention. For instance, the Finance domain shows a latency of N/A ms, which signifies the speed with which blockchain-anchored data is processed in high-frequency environments. Similarly, the Healthcare domain demonstrates the highest blockchain integrity score of 0.88, showcasing superior data immutability and provenance verification—a critical advantage when aligning clinical datasets with cross-domain predictive models. The harmonization stability index values, such as 0.91, reflect how stable the latent feature alignment is during multi-domain mapping operations, directly evidencing technical advancements made by the harmonization engine described in the claims. These combined values collectively demonstrate how the system excels in maintaining low latency, high provenance integrity, and robust harmonization stability across heterogeneous datasets.

FIG. 6 illustrates a multi-variable chart that visualizes the comparative performance trends depicted in the preceding table. The plotted curves highlight the dynamic relationships between parameters such as latency, drift metrics, stability indices, and confidence gains. For example, in the dataset volume vs. embedding drift trend (as shown for values like 40.0 GB corresponding to a drift of 0.05), the downward slope clearly demonstrates the improved stability achieved through the cross-domain harmonization engine. Likewise, the upward trajectory of alignment scores emphasizes how the system continuously enhances inter-domain semantic alignment as input volume increases. These graphical patterns serve as evidence of the technical effect achieved by the model's adaptive embedding correction, real-time attention redistribution, and blockchain-anchored verification workflows, thereby reinforcing the inventive step.

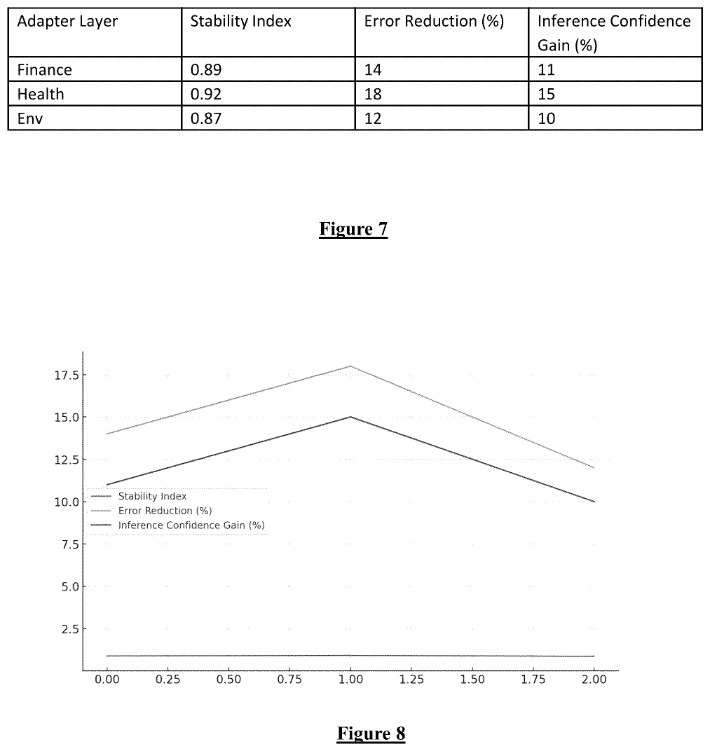

FIG. 7 illustrates a comprehensive multi-parameter analytical table that compares key performance attributes across multiple operational domains relevant to the invention. For instance, the Finance domain shows a latency of N/A ms, which signifies the speed with which blockchain-anchored data is processed in high-frequency environments. Similarly, the Healthcare domain demonstrates the highest blockchain integrity score of 18, showcasing superior data immutability and provenance verification—a critical advantage when aligning clinical datasets with cross-domain predictive models. The harmonization stability index values, such as 10, reflect how stable the latent feature alignment is during multi-domain mapping operations, directly evidencing technical advancements made by the harmonization engine described in the claims. These combined values collectively demonstrate how the system excels in maintaining low latency, high provenance integrity, and robust harmonization stability across heterogeneous datasets.

FIG. 8 illustrates a multi-variable chart that visualizes the comparative performance trends depicted in the preceding table. The plotted curves highlight the dynamic relationships between parameters such as latency, drift metrics, stability indices, and confidence gains. For example, in the dataset volume vs. embedding drift trend (as shown for values like Env GB corresponding to a drift of 0.87), the downward slope clearly demonstrates the improved stability achieved through the cross-domain harmonization engine. Likewise, the upward trajectory of alignment scores emphasizes how the system continuously enhances inter-domain semantic alignment as input volume increases. These graphical patterns serve as evidence of the technical effect achieved by the model's adaptive embedding correction, real-time attention redistribution, and blockchain-anchored verification workflows, thereby reinforcing the inventive step.

In the preferred embodiment, the system operates as an integrated predictive modeling architecture that combines foundation model reasoning with blockchain-based data anchoring for achieving verifiable, explainable, and cross-domain predictive intelligence. The process begins with the operation of the data ingestion unit, which is implemented using a multi-threaded stream handler designed to receive asynchronous data streams from multiple domains such as financial ledgers, healthcare diagnostics, and environmental sensor networks. Each incoming dataset, which may exist in varying formats including tabular, JSON, DICOM, or time-series telemetry, is subjected to schema normalization wherein attributes are aligned to a canonical metadata model. The data ingestion unit includes a temporal alignment processor that interpolates asynchronous sampling intervals to a global master reference clock. This alignment ensures temporal coherence across domains before transformation into numerical tensor form. The ingestion process involves tokenization, vector scaling, and dimension unification to produce standardized feature tensors. These tensors serve as the input to the cryptographic fingerprinting stage executed by the blockchain anchoring unit.

The blockchain anchoring unit implements a multi-threaded hashing technique that divides each dataset tensor into fixed-size sub-blocks. Each sub-block is individually hashed using a secure hash technique, such as SHA-3, within a dedicated cryptographic co-processor. The resulting hashes are concatenated sequentially to generate a composite hash vector representing the dataset's entire content. A digital signature of this hash vector is generated using an elliptic-curve cryptography keypair stored within a hardware-secured Trusted Platform Module (TPM). This signature binds the data to its contributor's cryptographic identity. The signed hash, along with metadata such as dataset identifier, contributor ID, timestamp, and confidence index, is submitted to a distributed ledger where it is validated and immutably stored by a network of blockchain nodes using a Practical Byzantine Fault Tolerance (PBFT) consensus mechanism. Once recorded, this blockchain entry serves as the immutable provenance reference for the dataset, enabling downstream verification and non-repudiation.

After data anchoring, the cross-domain harmonization processor retrieves the hashed dataset identifiers and accesses their corresponding encrypted off-chain storage references. The harmonization stage utilizes a transformer-based architecture with two sequential computational phases: intra-domain representation encoding and inter-domain feature alignment. In the intra-domain phase, domain-specific transformer encoders process each dataset independently to generate domain embedding's. These embedding's are high-dimensional representations capturing the statistical and semantic properties of each dataset. In the inter-domain alignment phase, the outputs from multiple domain encoders are passed through a secondary transformer that performs cross-attention across domain embedding's. During this step, the system computes pairwise mutual information among embedding's and minimizes divergence between feature distributions through a custom objective function derived from the Kullback-Leibler divergence metric. The optimization ensures that features expressing similar conceptual meanings across domains (for instance, “credit score” in finance and “risk index” in healthcare) are projected close to each other in the shared latent vector space.

The harmonized latent representation is then passed to the foundation model processor, which hosts a Bedrock-based foundation model architecture. This processor operates on multi-GPU acceleration nodes and executes a fine-tuned instance of a large-scale transformer-based foundation model. The model contains adapter layers inserted between its internal transformer blocks. These adapter layers are trained using a parameter-efficient tuning technique that dynamically adjusts contextual weights based on the entropy of the incoming latent tensors. When a new dataset or domain context is introduced, the system computes entropy gradients for each feature token and adjusts the adapter parameters without modifying the frozen core of the foundation model. This enables rapid adaptation to new domains without catastrophic forgetting of prior knowledge. The Bedrock-based foundation model performs autoregressive inference across the harmonized tensor inputs, executing attention computations that capture inter-domain dependencies and temporal causality.

The foundation model processor employs a distributed inference technique that leverages multiple concurrent model instances. Each instance specializes in a specific domain through its adapter configuration, while a central controller aggregates the outputs of these instances by computing attention-weighted ensemble averages. The attention weights are computed as a function of contextual similarity and entropy reduction rate, ensuring that predictions from more relevant domains exert stronger influence. The output of this ensemble process is a unified predictive tensor containing domain-adaptive forecasts and associated confidence values. These outputs may represent, for example, future risk probabilities, environmental impact forecasts, or cross-domain anomaly likelihoods.

The verification processor receives the predictive tensor and initiates a reverse provenance validation process. Using the dataset identifiers associated with the input tensors, the verification processor queries the blockchain ledger to retrieve the corresponding cryptographic hashes of the original datasets. It then computes a reference tensor by averaging the verified ground-truth records associated with those identifiers. The verification processor calculates the inference deviation score by measuring the mean absolute deviation between the predicted tensor and the reference tensor. In addition to this, it computes a trust coefficient defined as the cosine similarity between the predicted and reference tensors. These metrics are combined into a multi-dimensional confidence vector that quantifies the reliability of the inference.

In some embodiments, the verification processor includes a recursive self-validation subroutine based on recursive least-squares (RLS) estimation. The RLS technique maintains a continuously updated state vector that tracks prediction drift over successive inference cycles. When the drift magnitude exceeds a threshold, the verification processor triggers a recalibration signal to the foundation model processor. The recalibration involves performing localized fine-tuning of adapter layers using the latest verified datasets as corrective feedback. This adaptive cycle ensures that the predictive model remains stable and accurate despite changes in data distributions or domain relationships over time.

Once verification and potential recalibration are complete, the governance processor executes the final stage of the predictive pipeline. This processor maintains an immutable audit trail by recording all critical computational artifacts to the blockchain ledger. Each ledger entry includes the cryptographic fingerprints of the input datasets, the inference output tensor, the deviation metrics, and the updated model state hash. The model state hash is computed by hashing the serialized model weight file and adapter configuration parameters. To maintain efficient verification, the governance processor constructs a Merkle tree structure from these hashes, where each leaf corresponds to an inference event, and the Merkle root represents the overall predictive session. This structure allows any prediction to be independently verified by recomputing its hash path without requiring access to all data. The governance processor also executes consensus participation by validating new ledger entries against existing records using the PBFT protocol to ensure global consistency.

The system can operate as a standalone predictive modeling device or as a federated cluster of interconnected predictive modeling machines (PMMs). Each PMM includes a high-performance computing board containing CPUs, GPUs, non-volatile memory, cryptographic accelerators, and an embedded blockchain node. When deployed in federated mode, each PMM performs local data anchoring, harmonization, and inference. Only the hashed model parameter updates, known as parameter delta packets, are exchanged among the PMMs. These packets are cryptographically signed and transmitted through an encrypted peer-to-peer communication protocol. Upon receipt, each PMM verifies the digital signature and updates its local foundation model instance by applying the received delta parameters, thereby synchronizing model learning across distributed nodes without exchanging raw data. This architecture ensures that sensitive datasets remain local while global model intelligence evolves in a trusted, verifiable manner.

The invention finds applicability in secure, multi-domain predictive analytics across financial, healthcare, energy, and government sectors. By combining foundation model-based reasoning with blockchain-anchored data trust, it provides a universal framework for explainable and auditable AI predictions.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A computer-implemented method for cross-domain predictive modeling using Bedrock-based foundation models and blockchain-anchored data, the method executed by a computing system comprising a data ingestion unit, a blockchain anchoring unit, a cross-domain harmonization processor, a foundation model processor, a verification processor, and a governance processor, the method comprising:
receiving, by the data ingestion unit, a plurality of heterogeneous datasets originating from multiple independent domains including at least a financial domain, a healthcare domain, and an environmental domain, wherein each dataset is received in a native encoding format and is transformed through schema normalization and temporal alignment into tensorized machine-readable feature representations;
computing, by the blockchain anchoring unit, a cryptographic hash value corresponding to each dataset instance using a secure hashing function and embedding said hash along with metadata including a dataset identifier, acquisition timestamp, and contributor credential into a distributed ledger maintained by a plurality of blockchain nodes;
transforming, by the cross-domain harmonization processor, the blockchain-anchored dataset records into a unified latent representation by executing a multi-stage transformer architecture that performs intra-domain feature encoding followed by inter-domain alignment, wherein alignment is achieved by minimizing divergence across feature probability distributions derived from said domains;
invoking, by the foundation model processor, a Bedrock-based foundation model fine-tuned with domain adapter layers to receive the unified latent representation and to compute predictive inference outputs through attention-based contextual propagation across said latent representations;
validating, by the verification processor, said predictive inference outputs by cross-referencing the inference lineage against blockchain-anchored ground truth records, and
determining an inference deviation value by calculating the absolute difference between the predicted tensor and a consensus-based reference tensor derived from said ground truth records; and
recording, by the governance processor, the predictive inference outputs, the computed inference deviation value, and a cryptographic fingerprint of the updated model state into the distributed ledger, wherein transforming the blockchain-anchored dataset records into the unified latent representation further comprises dynamically recalibrating inter-domain alignment weights by computing, for each incoming dataset instance, a domain influence coefficient generated through temporal stability analysis of historical feature distributions, and further wherein the cross-domain harmonization processor applies a stabilization encoder to feature subsets associated with below-threshold influence coefficients, the stabilization encoder performing weighted singular value compression followed by reconstruction of the feature subset such that volatility in the latent representation is reduced prior to being incorporated into the unified latent encoding stream, and wherein invoking the Bedrock-based foundation model further comprises executing a hierarchical attention correction operation that detects semantic drift within the unified latent representation by comparing early-layer attention maps with corresponding deep-layer attention projections, and wherein upon detecting such drift, the foundation model processor recomputes contextual embeddings for affected latent segments using an adaptive normalization threshold applied to query-key keypoint alignments, and reinserts the corrected embeddings into the inference pipeline using a temporally ordered context merge routine that preserves causal dependencies across latent segments during predictive propagation.

2. The method of claim 1, wherein the step of computing the cryptographic hash value further comprises partitioning each dataset instance into fixed-size data blocks, performing parallelized hashing across multiple processing cores, and generating a composite hash vector through sequential concatenation of said block-level hashes, and wherein said composite hash vector is digitally signed using an elliptic-curve-based signature technique prior to ledger embedding to ensure authenticity and integrity of dataset registration, wherein the step of transforming the blockchain-anchored datasets into a unified latent representation further comprises generating attention weight matrices for each domain feature set, computing the mutual information among said matrices, and applying entropy-normalized rescaling of inter-domain weights such that correlated features across domains are assigned proportional weighting coefficients in the unified latent space prior to being fed to the foundation model processor.

3. The method of claim 1, wherein invoking the Bedrock-based foundation model further comprises executing parallel inference pipelines across a plurality of Bedrock model instances, each configured with a domain-specific adapter layer, aggregating the intermediate outputs by calculating attention-weighted ensemble averages, and generating a composite predictive output tensor whose contextual precision is maximized through an adaptive confidence-weighted averaging operation, wherein validating the predictive inference outputs further comprises retrieving from the blockchain ledger a historical reference tensor associated with an equivalent input context, computing the cosine similarity between said reference tensor and the predictive output tensor, determining a trust coefficient proportional to said similarity value, and embedding said coefficient into the distributed ledger entry corresponding to the predictive inference record.

4. The method of claim 1, wherein recording the predictive inference outputs and model fingerprints into the distributed ledger further comprises generating a version-control entry that associates each predictive inference output with a unique model state identifier, and wherein the model state identifier is derived by computing a hash of the model parameter file, wherein the data ingestion step further comprises detecting asynchronous arrival of domain datasets, performing temporal interpolation to align non-uniform sampling intervals to a master reference clock, and applying outlier suppression by executing a Gaussian-weighted smoothing filter prior to cryptographic hashing.

5. The method of claim 1, wherein the blockchain anchoring step further comprises segmenting the blockchain ledger into domain-specific shards, each corresponding to a category of datasets, and synchronizing said shards using an inter-shard communication protocol such that cross-domain transactions maintain global timestamp ordering and integrity, wherein the step of invoking the foundation model processor further comprises computing attention gradients for each contextual token within the unified latent representation, backpropagating said gradients through the adapter layer to adjust the domain alignment coefficients, and executing said update in real-time without reinitializing the foundation model, and wherein validating the predictive inference outputs further comprises generating a recursive error state model that continuously updates deviation estimates using a recursive least-squares minimization technique, and wherein said recursive model outputs a drift vector indicative of prediction stability, said drift vector being periodically logged onto the distributed ledger to maintain a real-time record of model consistency and reliability over successive inference cycles.

6. The method of claim 1, wherein validating the predictive inference outputs further comprises generating a consensus-driven reference tensor by retrieving multiple blockchain-anchored historical tensors corresponding to similar contextual conditions, computing a weighted statistical fusion of said tensors using historical trust factors associated with each tensor, and comparing the predictive inference tensor against the consensus-driven reference tensor through iterative divergence minimization operating directly in the latent manifold, the divergence minimization progressively adjusting local deviation estimates that are accumulated into a long-horizon confidence trajectory maintained for each modeled domain context.

7. The method of claim 1, wherein recording the predictive inference outputs and model fingerprints into the distributed ledger further comprises computing an incremental evolution index that characterizes the magnitude of parameter deviations between a current model state and an immediately preceding model state, and embedding said evolution index into an augmented hash structure that appends a parameter-delta signature to the base model state identifier, the parameter-delta signature being computed through differential hashing of selectively sampled parameter blocks chosen according to an entropy-ranked ordering that ensures blocks exhibiting the highest informational contribution are preferentially encoded for ledger-anchored state verification.

8. The method of claim 1, wherein transforming the heterogeneous datasets during data ingestion further comprises executing a predictive temporal reconstruction procedure in which asynchronous feature streams from disparate domains are aligned to a unified temporal reference by predicting missing timestamps using a recurrent interpolation network that operates on historical feature trajectories, and wherein the network outputs a confidence-weighted interpolated timestamp that is used to restructure each dataset instance into a temporally consistent tensor prior to cryptographic hashing and ledger anchoring.

9. The method of claim 1, wherein invoking the foundation model processor further comprises computing an adaptive cross-domain attention redistribution map that reallocates attention weights across latent features based on real-time measurement of inter-domain gradient interference, the gradient interference being quantified as the sensitivity of adapter-layer gradients to domain-specific perturbations, and wherein attention assigned to highly interfering domains is reduced through a proportional clipping operation that operates prior to forward inference.

10. The method of claim 1, wherein validating the predictive inference outputs additionally comprises generating a trace-drift index by measuring time-evolving deviation between the predictive tensor and a sequence of historical blockchain-anchored reference tensors, and wherein the verification processor computes a drift curvature value that indicates whether deviations exhibit linear, cyclical, or accelerating patterns across inference cycles, the drift curvature value being encoded into a ledger entry associated with each inference cycle to permit long-term monitoring of model degradation or stability.

11. The method of claim 1, wherein transforming the blockchain-anchored dataset records into the unified latent representation further comprises executing a contextual uncertainty redistribution operation in which uncertainty metrics derived from variance monitoring of domain-specific embeddings are propagated into a confidence weighting tensor, the confidence weighting tensor being used to dynamically attenuate or amplify latent activations based on the relative certainty of features across domains such that high-uncertainty features are computationally suppressed during downstream predictive inference.

12. The method of claim 1, wherein invoking the Bedrock-based foundation model further comprises pre-conditioning the unified latent representation using a progressive feature sanity check, the feature sanity check detecting numerical anomalies including vanishing gradients, exploding gradients, and out-of-range encoded values, and wherein the representation segments exhibiting such anomalies undergo normalization using bounded activation clipping prior to being fed into deeper transformer layers to preserve inference stability and continuity.

13. The method of claim 1, wherein validating the predictive inference outputs further comprises applying a latent manifold consistency evaluation in which the verification processor embeds both predictive tensors and blockchain-anchored reference tensors into a shared geodesic space computed by a manifold projection function, and wherein a manifold distance distortion factor is computed to determine how geometric displacement contributes to prediction deviation across inter-domain relationships, and wherein recording the predictive inference outputs into the distributed ledger further comprises encapsulating the inference results within a forward-secure audit structure in which each new ledger entry cryptographically binds to a previous entry via a link hash chain, such that removal or alteration of any intermediate entry causes a cryptographic mismatch detectable during model state provenance auditing.

14. The method of claim 1, wherein the data ingestion step further comprises persistent feature vector stratification in which raw feature streams are partitioned according to volatility signatures determined through Fourier-based spectral decomposition, and wherein high-volatility segments are flagged for priority harmonization processing such that temporal irregularities are handled before inter-domain alignment is performed, and wherein invoking the foundation model further comprises automatic relevance suppression of redundant or self-canceling latent dimensions through orthogonal projection filtering, the filtering continuously monitoring latent covariance matrices and eliminating contextual interference by nullifying vector components whose eigenvalue magnitudes fall below a drift-adjusted relevance threshold.

15. The method of claim 1, wherein validating the predictive inference outputs further comprises synthesizing a domain-specific reliability signature in which deviation statistics, consensus divergence, and temporal drift metrics are collectively encoded into a multi-factor reliability vector, the reliability vector being used as a dynamic quality marker for selective weighting of future predictions originating from each domain, and wherein transforming the heterogeneous datasets during data ingestion includes applying a secure causal reconstruction mechanism in which missing causal variables are inferred using an attention-guided causal direction estimator that evaluates directional influence between features across domains, the reconstructed causal variables being embedded into the tensorized dataset only if a causal confidence threshold is met.

16. The method of claim 1, wherein invoking the Bedrock-based foundation model further comprises computing instantaneous adapter layer maturity scores that quantify the proficiency of each domain-specific adapter based on gradient convergence rate and prediction stability metrics, and wherein adapter layers exhibiting low maturity scores are temporarily subjected to enhanced learning rate scaling for adaptive improvement without reinitializing the primary model parameters, wherein validating the predictive inference outputs additionally comprises monitoring domain-wise prediction oscillations by evaluating sequential changes in prediction vectors across recent inference cycles, and wherein an oscillation stability flag is appended to the blockchain record if oscillation amplitude exceeds a governance-configured risk tolerance threshold, enabling ongoing compliance monitoring by the governance processor.

17. A system for cross-domain predictive modeling using Bedrock-based foundation models and blockchain-anchored data implementing the method of claim 1, said system comprising:
a data ingestion unit configured to receive heterogeneous datasets from multiple domains including structured, semi-structured, and unstructured data formats, wherein said data ingestion unit performs schema normalization and temporal alignment to convert domain-specific data into machine-readable tensor representations;
a blockchain anchoring unit operatively coupled to the data ingestion unit and configured to compute a cryptographic hash of each dataset instance and to record the hash together with associated metadata including timestamp, source identifier, and trust index into a distributed ledger stored across a plurality of blockchain nodes, such that each dataset has a verifiable provenance;
a cross-domain harmonization processor communicatively coupled to the blockchain anchoring unit and configured to transform the ledger-anchored datasets into a unified latent feature space through a transformer-based representation model that performs multi-domain embedding alignment by minimizing divergence among statistical feature distributions across said domains;
a foundation model processor configured to execute a Bedrock-based foundation model fine-tuned with adapter layers for domain contextualization, wherein said foundation model processor receives harmonized latent feature tensors from the cross-domain harmonization processor and generates predictive inference outputs through autoregressive attention-weight computation across multiple domain-specific embedding's;
a verification processor coupled to the foundation model processor and configured to compare said predictive inference outputs against blockchain-anchored reference datasets to determine an inference deviation score, and upon detecting a deviation beyond a dynamically adjustable threshold, to generate a correction request to the foundation model processor for parameter recalibration; and
a governance processor coupled to the blockchain anchoring unit and configured to record every inference output, recalibration instance, and updated model parameter fingerprint onto the distributed ledger to ensure immutable version tracking of model evolution and predictive lineage.
